(19) United States
(12) Patent Application Publication
(10) Pub. No.: US 2014/0095307 A1
(43) Pub. Date: Apr. 3, 2014

(54) SPOTTING TRENDS BY IDENTIFYING INFLUENTIAL CONSUMERS

(71) Applicants: Joseph Dodson, San Diego, CA (US); Mohammed A. Khan, Poway, CA (US)

(72) Inventors: Joseph Dodson, San Diego, CA (US); Mohammed A. Khan, Poway, CA (US)

(73) Assignee: Sony Computer Entertainment America LLC, Foster City, CA (US)

(21) Appl. No.: 13/631,604

(22) Filed: Sep. 28, 2012

(51) Int. Cl. G06Q 30/02

(52) U.S. Cl. CPC G06Q 30/0255
USPC 705/14.53

(57) ABSTRACT

Relevant information for a plurality of consumers may be gathered from a plurality of electronic devices. Influence information is determined from a correlation between the relevant information and one or more items. The influence information may be used to identify one or more influencers. Information gathered from contemporary online behavior of the one or more influencers with respect to one or more categories of items may be used to identify a trend with respect to one or more particular items in the one or more categories. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope or meaning of the claims.

### TECHNICAL FIELD

This application generally relates to identifying influential consumers and spotting consumer trends by monitoring activity among consumers.

### BACKGROUND

Users of social networking websites and digital communication tools (e.g. email, telephony, video conferencing, instant messaging, web browsing, music players, media players, etc.) may view, listen or access various different types of media from the Internet while being logged into a social network website, other site or an information sharing application. Such media may include music, books, audio, video, photos, text, blogs, articles or any type of content. When new media emerges, user behavior may indicate what media is popular by examining, for example, the number of views a video may achieve.

Advertisers and other interested parties may find it useful to determine when a new video, song or other media is first emerging as being popular or potentially being popular among a particular demographic and time. If an emerging trend can be spotted in its early stages advertisers can better prepare to take advantage of the trend in advertising campaigns as the trend increases in popularity.

However, it is difficult to identify content that is growing in popularity but not yet at a stage when it has gone “viral” and has already been consumed by a large number of individuals and/or devices.

It is within this context that aspects of the present disclosure arise.

### BRIEF DESCRIPTION OF THE DRAWINGS

FIG. 1 is a schematic diagram illustrating how an item of content may grow in popularity among a group of consumers.

FIG. 2A is a graph of popularity of a content item as a function of time.

FIG. 2B is a graph illustrating the change in popularity as a function of time for the graph in FIG. 2A.

FIG. 3A is a flow diagram of a method for identifying influencers among a group of consumers according to an aspect of the present disclosure.

FIG. 3B is a flow diagram of a method for spotting a trend among a group of consumers according to an aspect of the present disclosure.

FIG. 4 is a block diagram illustrating an example of using interconnected devices to implement methods for identifying influencers and spotting trends according to aspects of the present disclosure.

### DETAILED DESCRIPTION

### Introduction

The potential popularity of a particular item may be estimated by determining whether the item is promoted by one or more particularly influential consumers. For convenience, such influential consumers are referred to herein as “influencers”. Interest in an item of content may suddenly grow exponentially after the content is promoted by an “influencer”.

The problem is twofold. First, one has to determine which consumers are “influencers” with respect to a particular type of content. Second, one has to track identified influencers' behavior to determine what content they are promoting at an early stage.

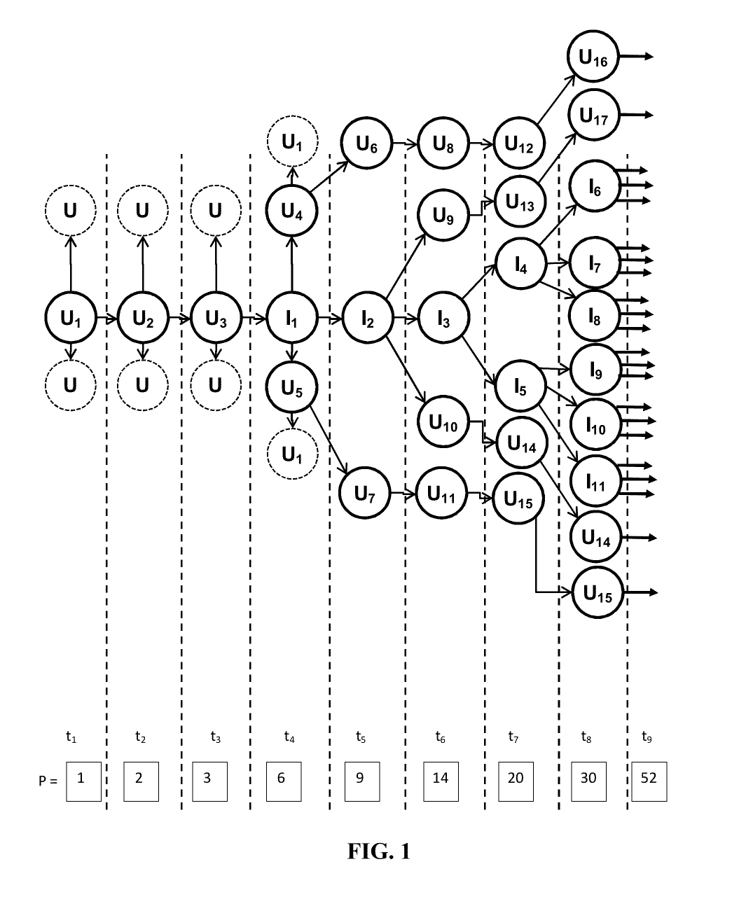

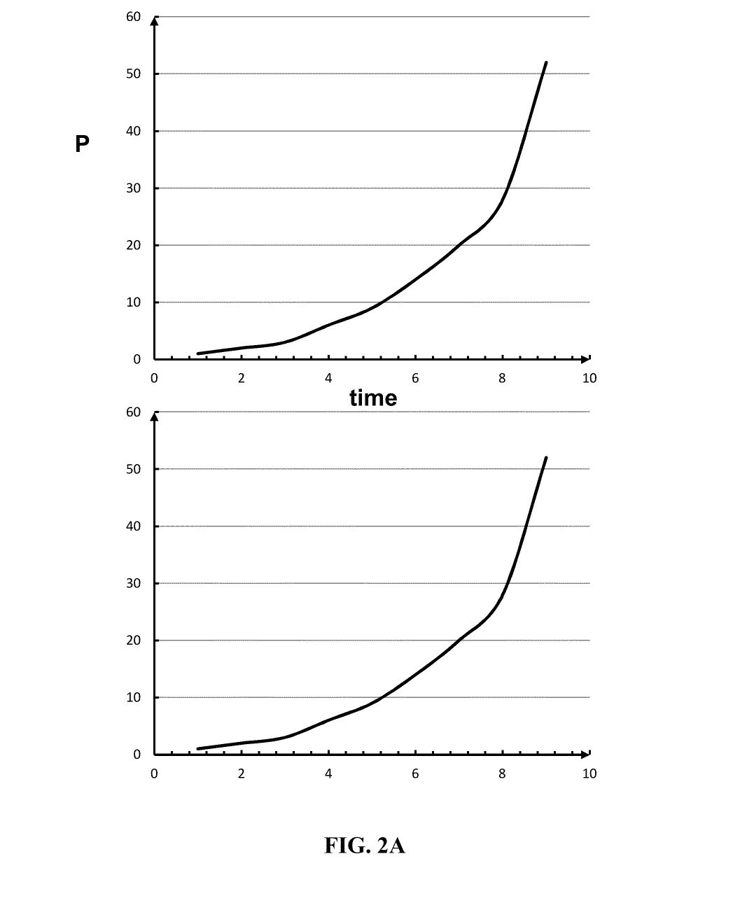

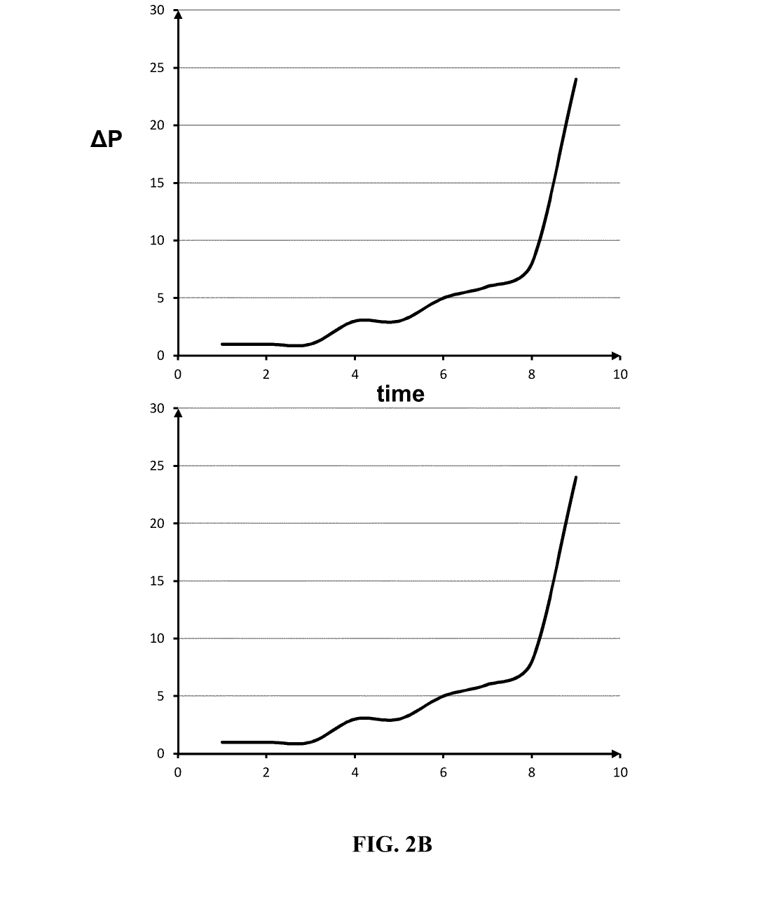

The growth in popularity of an item of content may be understood by referring to FIG. 1 and FIG. 2A and FIG. 2B. The item in question may be an item of media content, e.g., a song, an album, an article, a video, a movie, a television program that can be transmitted electronically. However, trends in popularity may also occur with goods or services, such as automobiles, clothing, food, drink, vacation destinations, restaurants, bars, nightclubs, airlines. Items may also include abstract ideas in art, science, literature, politics, and the like. The list of items that may be subject to trends is essentially endless. In theory, a trend in popularity could develop for anything that can be named.

For the purposes of the following example, suppose the item in questions is a media content item, such as a song by a new artist. FIG. 1 diagrammatically illustrates an example of a trend in growth a group of connected consumers. The consumers may be connected to each other through social media. Suppose, again for the sake of example, that each consumer is “connected” in some way to three other consumers. For example, if the consumers are connected via social media, such as Facebook, each consumer has three “friends”. Consumers may recommend an item of content to their friends, e.g., by clicking on “Like” button for the content item. For the sake of example, assume that when a particular consumer recommends an item of content, the recommendation is sent to the three other consumers connected to the particular consumer.

According to aspects of the present disclosure, it is recognized that not all recommendations are equal. Often, the effectiveness of a recommendation depends on which particular consumer is making the recommendation. To illustrate this point suppose that there are two types of consumers: normal consumers Uᵢ and “influencers” Iⱼ. For the purposes of example, the difference between these two types is as follows. When a normal consumer recommends an item of content only one of the three friends acts on the recommendation. When an influencer recommends an item of content all three friends act on the recommendation. For the purposes of example, a consumer may act on a recommendation by purchasing or downloading the recommended item or passing their recommendation of the recommended item on to other consumers. A consumer may also act on the recommended item by spending time with a recommended item (e.g., playing a recommend video game), writing about the recommend item online (e.g., in a blog post, online article or online chat), or indicating approval of the item via a social media service (e.g., by clicking on a “Like” button for the item. The more consumers act on recommendations, the more popular the item becomes.

FIG. 1 illustrates the effect influencers can have on the popularity of an item of content over time. Time intervals are indicated by dashed vertical lines. Each time a recommendation is acted upon, popularity P of the item increases by 1. Suppose at some initial time t₁ an ordinary consumer U₁ acts on an item of content and recommends the item of content to three connected consumers U₁ is an ordinary consumer and only one connected consumer (U₂) recommends the item to three others at t₂. Of these three others only one (U₃)recommends the item to three others at t₃ including an influencer I₁. At t₄ point the growth rate increases due to the effectiveness of recommendations by the influencer I₁. Recommendations from the influencer I₁ are acted upon by two ordinary consumers U₄ and U₅ and a second influencer I₂ at t₅. The second influencer 1₂ further increases the growth in popularity P. in Recommendations from the ordinary consumers U₄ and U₅ are acted upon by ordinary consumers U₆ and U₇, respectively at t₆. As recommendations reach more and more influencers, the rate of popularity can grow exponentially.

It is noted that a number of different factors can affect the growth in popularity. For example, if an influencer has more connections then that influencer may potentially have a bigger impact. Furthermore, if an influencer is connected to a significant number of other influencers, the multiplier effect can be enormous in the early stages of the spread of popularity of an item. For example, notice the tremendous jump in popularity after influencer I₃ passes recommendations on to influencers I₄ and I₅.

As may be seen from the graphs in FIG. 2A and FIG. 2B, the growth in popularity of the item is linear between t₁ and t₃. Increases linearly at a greater rate between t₃ and t₅ and then increases in a highly non-linear fashion after t₆.

A number of things may be appreciated from FIG. 1 and FIGS. 2A-2B. First, the effect of influencers may be seen by abrupt and dramatic changes in the rate of growth of popularity P. Second, if the influencers can be identified in advance, it is possible to estimate the growth of popularity of a new item by monitoring recommendations of an item by consumers and determining whether the item is recommended by enough influencers at an early stage. It is noted that abrupt changes in popularity may be easier to spot from a plot of the rate of change of popularity (ΔP) over time, e.g., as shown in FIG. 2B. Of course, it is unreasonable to expect that the popularity P the rate of change of popularity ΔP to continue to grow indefinitely, however, if one can detect the early stage of growth of popularity amongst influential consumers one can potentially spot a trend before it becomes widespread. This ability can be extremely useful, e.g., for promoting, marketing, and advertising media content items.

### Identifying Influencers Among Consumers

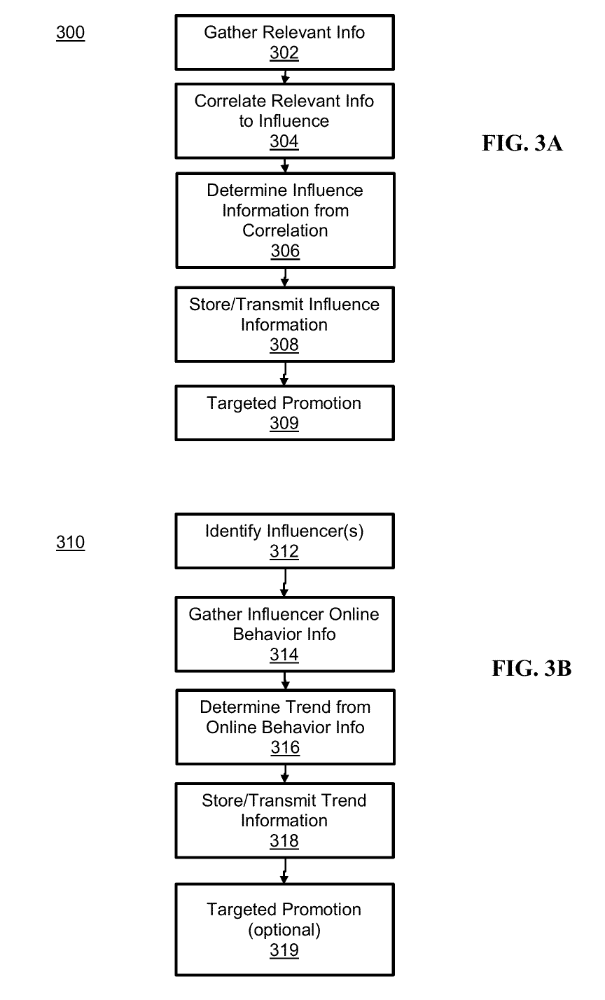

According to an aspect of the present disclosure, the concepts discussed above may be harnessed to identify influencers among a group of consumers. An example of a method 300 for identifying such influencers is illustrated diagrammatically in FIG. 3A. In general, the relevant information may be gathered, as indicated at 302. By way of example, and not by way of limitation, social media services may be configured to collect the information needed to identify influencers and to track their recommendations. It is noted that influencers can be identified by an arbitrary number or other identifier without obtaining any personal identifying information about the user. Instead, it is useful to gather relevant information such as:

1) What types of items has a given consumer recommended?

2) What other consumers received such recommendations from the given consumer?

3) What number or proportion of the other consumers who received recommendations from the given consumer acted on those recommendations from the given consumer?

Social media services may retain historical data related to questions 1) and 2), e.g., by storing an item identifier and consumer identifiers associated with the consumer making and the consumer(s) receiving the recommendation in a database record when the consumer makes a recommendation of an item. The social media service may implement this automatically at its server(s). The server may also store other relevant information, such as the date and time of the recommendation. The server may also monitor the behavior of the user's receiving the recommendation to determine if they act upon the recommendation, either by forwarding the recommendation to other users, purchasing the recommended item, favorably review the recommended item, or perform other relevant actions related to the item. The server may associate this information with the recommending consumer's identifier in the database. The server may periodically query the database to calculate a number or proportion of recommendations from one consumer that get acted upon by other consumers.

By analyzing historical data related to these three questions it is possible to build up a picture of the degree and kind of influence a given consumer has on other consumers connected to the given consumer. With sufficient historical information it is possible to develop a correlation between recommendations by the given consumer and desired actions on these recommendations by other consumers, as indicated at 304. Desired actions may include purchases of items, free downloads of items, recommendations of items to others, and the like. Determining the correlation for a given consumer at 304 is largely a matter of comparing historical data for recommendations made by the given consumer to historical data for corresponding desired actions by other consumers who received the recommendations. For example, one could examine historical data for the popularity of items in a given category (e.g., determined from data for the number of search engine hits for items in that category over time) and perform a statistical correlation between an abrupt increases in popularity of items and recommendations of the items by a given consumer over some window of time preceding each abrupt increase. Consistently large correlations could suggest that the consumer has influence over the popularity of items in that category.

The correlation determined at 304 may then be used to determine influence information associated with the consumer, as indicated at 306. Such influence information may identify whether a given consumer is an influencer with respect to a given category of item. The influence information may also indicate a degree or strength of the influence that the given consumer has on other consumers. By way of example, and not by way of limitation, a given consumer may be identified as an influencer, if the correlation between recommendations and desired actions is above some threshold. Furthermore, there may be a hierarchy of influence, with higher correlations leading to higher influence levels. In addition, different degrees of influence may be associated with the consumer for different particular item categories, such as music, literature, or news.

Once a consumer has been identified as an influencer information relevant to influence associated with the consumer (referred to herein as “influence information”) may be stored in an electronic database or transmitted in electronic form to interested parties as indicated at 308. Examples of interested parties may include advertisers, talent scouts, media organizations (e.g., radio stations, and the like), social media companies, public relations firms, political parties, polling organizations, and the like.

Examples of influence information include, but are not limited to an identifier associated with the consumer, a list of relevant categories of items, and corresponding influence ratings for each relevant category. By way of example, relevant categories may be organized in terms of the type of item (e.g., music, literature, news, video games, electronic devices, consumer goods, and the like) or by sub-categories, e.g., genre of music, literature, or video game. Other examples of useful influence information may include identifiers of “connected” consumers. As used herein, the term “connected consumer” is used to generally indicate other consumers having some relationship to the given consumer. For example, a connected consumer may be one to whom the given consumer regularly sends recommendations. Alternatively, the connected consumer may have a known or knowable social relationship to the given consumer, e.g., they may be neighbors, spouses, co-workers, professional colleagues, members of a common organization or social network, “Friends” on Facebook, and the like.

Influence information may also reflect the nature of the influence one consumer has on another. For example, recommendations of an item from an influencer might consistently lead other consumers to also recommend the item. This type of influence may be useful, but it may be more relevant if recommendations of an item consistently led to purchases of the item.

Influence information may be organized and displayed in the form of “heat maps” that show where influence resides in a relevant space of consumers. In such heat maps, the “space” of relevant consumers may be displayed as a two-dimensional map with different colors representing differing degrees of influence for particular consumers. Displaying information in this manner can make it easier to spot influential consumers and connections between influencers.

Influence information may be tailored to meet the needs of interested parties. For example, if the interested party is a music talent scout, the influence information distributed to the talent scout may be limited to that which is relevant to music.

Once influential consumers have been identified as an influencer, it is possible to use information about connections among such influencers to target electronic promotions, as indicted at 309. In particular, promotions may be electronically targeted toward devices used by one or more influencers in a group of influencers who are connected to each other. The promotion may be run in connection with cookies and banner ads on an open system (such as the World Wide Web) or a closed system (such as Facebook). Targeting the promotion may be implemented, e.g., by strategically placing cookies for one advertisements related to the promotion on a website of an influencer in the group of influencers.

By targeting groups of connected influencers, a promotional campaign may efficiently and effectively focus its resources by targeting connected influencers. The connectedness of the influencers increases the likelihood that the promotion will start at “viral” trend.

Spotting Trends by Monitoring Activity among Influencers

According to aspects of the present disclosure, the influence information for a group of consumers may be used to spot trends according to a method 310 depicted in FIG. 3B.

Generally speaking, influencers are identified, as indicated at 312, e.g., as described above with respect to the method 300 of FIG. 3A. Once influencers have been identified from among a larger set of consumers, the online behavior of these influencers may be monitored, as indicated at 314. By way of example, and not by way of limitation, consumers who are members of a given social media service (e.g., Facebook, Twitter, etc.) may make relevant recommendations, purchases, or downloads through online activity. Information relating to this activity (e.g., items recommended, purchased, or downloaded) may be handled through one or more servers operated by the social media service and recorded in a database maintained by the social media service, or on its behalf.

A portion of the information in the database relating to activity by the identified influencers may be analyzed to determine a trend, as indicated at 316. For example, identifying the trend may include determining a growth in popularity of a content item among a group of consumers that includes the one or more influencers. This may be done, e.g., by tracking recommendations among the group of consumers, as discussed above with respect to FIG. 1 and FIGS. 2A-2B. Information relating to the trend may be stored in a computer-readable medium and/or transmitted to interested parties as indicated at 318.

By way of example, and not by way of limitation, suppose it is known that a certain group of influential consumers are connected to each other. Further suppose that each influential consumer is connected to a large number of other consumers over whom they have influence with respect to certain types of music. This information may be determined using the techniques described above. If an interested party, such as an advertiser, talent scout, or radio station, wishes to spot the next trend in music, online activity by the relevant influencers may be monitored to determine which musical artists or works are being strongly recommended by these influencers before the artists or works become generally known. By way of example, and not by way of limitation, one could determine whether an artist is “generally known” could be to compare the number of “hits” on an internet search engine for a search of the artist's name to some threshold level that can be based on a search for the name of an artist generally accepted as well known. For example, suppose a selected set of influencers in the field of music are recommending “the Black Keys” new album. Further suppose that a search on “Lady Gaga” on a general search engine returns about 300 million hits and a search on “the Black Keys” on the same search engine returns about 1.6 million hits. It is reasonable to infer that “the Black Keys” are not generally known the time of the searches.

By correlating artists being strongly recommended by identified influencers to the general popularity of those artists it is possible to spot a trend in popularity before the artist becomes generally known. For example, one could determine which artists were being recommended most often by the influencers during a given period of time. If the artists being most heavily recommend by the influencers are determined to be not generally known, e.g., based on search engine result as described above, these artists could then be identified for heavy promotion by interested parties. The interested parties may be notified of the potential trend identified from a growing pattern of recommendations by influencers among the general population of consumers.

In some implementations, an interested party may wish to act on the trend by taking action to further promote it or by taking advantage of it, e.g., by promoting it as indicated at 319. For example, when a trend is spotted with respect to an item of media content, such as a song, an article, or news item, an interested party may create a media file that includes the item recommended by the identified and at least one advertisement. The media file can then be sent electronically to devices belonging to targeted recipients, e.g., by way of email, pop-up advertisement, in-game advertisement, and the like. Targeted recipients may be selected from among consumers who are influencers or consumers connected to the influencers.

In particular, as discussed above, promotions may be electronically targeted toward devices used by one or more influencers in a group of influencers who are connected to each other. The promotion may be run in connection with cookies and banner ads on an open system (such as the World Wide Web) or a closed system (such as Facebook). Targeting the promotion may be implemented, e.g., by strategically placing cookies for one advertisements related to the promotion on a website of an influencer in the group of influencers.

### Using Devices to Identify Influencers and Spot Trends

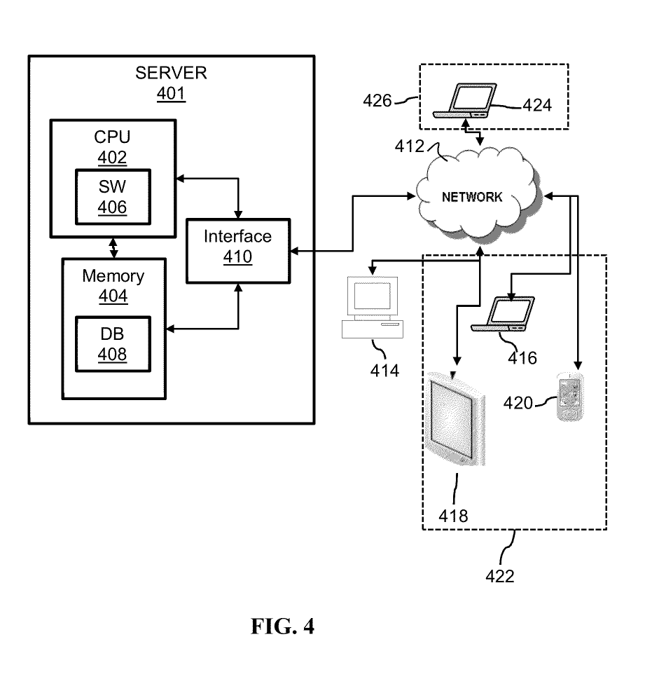

According to certain aspects of the present disclosure, the methods described above may be implemented on one or more suitably configured electronic computing devices. By way of example, and not by way of limitation, as illustrated in FIG. 4, a server 401 may include a processor 402, coupled to a memory 404. The memory 404 or other non-transitory storage medium may be coupled to the processor 404 such that the processor may read information from, and write information to, the storage medium. In the alternative, the storage medium may be integral to the processor 402. The processor and the storage medium may reside in an application specific integrated circuit (“ASIC”). In the alternative, the processor and the storage medium may reside as discrete components. The processor and memory may be discrete components of a network entity that are used to execute an application or set of operations which may implement the method 300 of FIG. 3A and/or the method 310 of FIG. 3B. The application may be coded in software in a computer language understood by the processor 402, and stored in a non-transitory computer readable medium, such as, the memory 404. The computer readable medium may be a non-transitory computer readable medium that includes tangible hardware components in addition to software stored in memory. Furthermore, a software module 406 may be another discrete entity that is part of the server 401, and which contains software instructions that may be executed by the processor 402. In addition to the above noted components, the server 400 may also include an interface 410 with a transmitter and/or a receiver configured to receive and/or transmit communication signals via a network 412. The network may be a wired or wireless data network, a local area network (LAN), wide area network (WAN), such as the Internet, cellular data network, or other similar network.

According to one example, the content server 401 may be part of a social network website (e.g., FACEBOOK®, TWITTER®, etc.), a content sharing website (e.g., HULU®, YOUTUBE®, etc.), a gaming website (e.g., PLAYSTATION®, GAIKAI®, etc.) a stand-alone or independent website or any other type of website, network, platform, organization or structure. A user may be logged into his or her personal account and navigating through content titles by querying or use specified options. The user may also be uploading his or her own content to the content server 401 while being logged into his or her account.

According to aspects of the present disclosure, user information may be gathered and distributed by the server 401 for purposes of the methods described above. In particular, relevant information relating to consumers may be obtained from electronic devices operated by consumers, which may be in communication with the server 401 over the network 412 or other computer.

The user devices may be personal computers 414, laptops 416, tablet computers 418 wireless or cellular phones 420. Further examples of suitable user devices include, but are not limited to a PDA, a game console, a portable game device, a client, a server or any device that contains a processor and/or memory, whether that processor or memory performs a function related to an aspect of the disclosure.

Users operating their user devices 414-420 may interact with the server 401 via any of a variety of communication mediums that are incorporated into the media. player on the display interface that accompanies the media content. For example, a media plug-in may be integrated with an online social networking website (e.g., TWITTER®, FACEBBOOK®, LINKEDIN, etc.), a chat application including, for example, GMAIL® Chat, INSTANT MESSENGER® chat, ICQ® chat, SMS chat, email applications, voice integration (e.g., telephony, VoIP, digital voice networking, etc.) or any other real-time digital communication medium. When users of these services recommend content items or download, purchase or otherwise act on recommendations, the server 401 may record relevant informal ion regarding the recommendation, download, purchase or other act in the database 408.

Although examples have been described in which relevant data are gathered by a centralized server 401, aspects of the present disclosure are not limited to such implementations. Alternatively, any or all of the operations discussed above may be implemented in whole or in part by the user devices. For example, as an initial operation, a user of user device 414 may be the first device to identify desired item media content. By way of example, the item of media or content may include one or more of audio, video, images, scents, etc., or any content that is identified by one or more of the five senses of a user operating and/or in proximity of their respective device(s).

In operation, the user device 414 may locate or upload the desired media content to the server 401. The user device 414 may have identified a game, video clip, song, image, etc., that the user desires to identify as likable, desirable or shareable with other users via a communication medium (e.g. SMS, email, instant messaging, website affiliation, social networking website, blog, etc.). The user device 414 may transmit the desired media content (or a link to a location for downloading the content) while providing a message that includes an indication regarding the type of content, a rating of the content (general audiences, mature audiences, workplace appropriate, etc.). The user may also simply transmit a message indicating that the content is likable, desirable, or preferred, etc., so his or her profile will be updated to reflect the recently identified content.

The server 410 may record in the user account a time that the user device 414 first identified the content and a corresponding preference and category (i.e., “like” vs. “not like”, “music” vs. “video”, etc.).

Other indications logged by the server 401 may be whether the content was consumed (i.e., watched, viewed, streamed, downloaded, or accepted). The term “consumed” may be indicative of receiving, processing, playing, displaying and/or occupying an entire media file(s) or session. Other user devices 414, 416, 418, 420 and 424 may also transmit a message to the server 401 indicating the desirability of a particular media content item. As more users indicate that the media content item is likable or desirable, the server 401 may note those users' accounts and seek to determine whether any of the devices 414, 416, 418, 420 and 424 are associated with “influencers”, e.g., as described above with respect to FIG. 3A.

The sever 401 may also seek to determine whether the content is going “viral” or is likely to become popular over the near future, e.g., by monitoring activity amongst “influencers” among the users of the devices 414, 416, 418, 420 and 424 as described above with respect to FIG. 3B. In some implementations, influencers may be rewarded when the influencers are associated with promoting the trend. For example, each of the user accounts associated with the messages received from user devices 414, 416, 418, 420 and 424 may receive credit for having identified the new content based on their rating (e.g., like, dislike, share, etc.), time (e.g., hour, minute, second, day, month, year). In some implementations, the first user who promotes an item may be rewarded a head-hunter fee or credit if the content ever becomes popular or generates advertisement revenue.

The media content item may grow in popularity as other user devices consume the item. Users of certain ones of the other devices 416, 418, and 420, for example, may notify the server 401 via their associated user account profiles that the desired content item is likable or should be noted as worthy of viewing by others (i.e., rated highly—five stars). The server 401 may compare information regarding users who indicate that the item is likable to identify the desired media content as being popular at a certain date and time and among a certain demographic of users (i.e., ages 15-18, 18-24, 25-35, etc.), or in a certain part of the country (i.e., the north, the south, the Midwest, etc.) or in a particular location (i.e., college town). Certain users 416, 418 and 420 may be located in a particular area or a common locality 422, such as a college campus and may provide a threshold amount of a consumption rate or a usage rate necessary to trigger the server 401 to consider the content as “potentially valuable” or as having advertisement potential. Other interested users, such as in the case of the user of device 424 may be in a separate or “other” locality 426. The server 401 may promote content items identified as being particularly valuable among a certain demographic in the common locality 422 to users in the other locality 426. The server 401 may identify as valuable content having a certain overall number of consumers from a particular locality or a threshold amount of consumption overall or a combination of both.

Once the consumption rate of a particular media content title becomes stronger or above a threshold consumption rate identified by the server 401, then a cross-referencing function or procedure may be performed to ensure that the content is becoming as popular as it appears to be based on the feedback received at the content server 401. In one example, the content server 401 may identify the user accounts of certain users associated with user devices 414-420 or other users to ensure that the new content, such as “comedy content X”, “rock band X”, or whatever the present content is of the desired media content, is in fact growing in popularity and has an increasing popular online presence. It is often desirable for the cross-referencing function to be independent of the contemporary online behavior of the one or more influencers among the users of the devices 414-420 and 424. Examples of such independent online cross-referencing operations may include queries or posts being performed on social media services FACEBOOK®, GOGGLE®, TWITTER®, and the like, or on search engines, such as GOGGLE®.

A number of variations on the implementations described above are possible. By way of example, and not by way of limitation, the server 401 may be configured to promote media content to end user devices based on the identified desired media content items identified by users. The end user devices 414-420 may be targeted user devices which are associated with corresponding user accounts. User profile information associated with the user accounts may be stored in the database 408. The user profile information may indicate a likelihood that the user accounts are appropriate recipients for promoted media content based on user preferences associated with the user accounts. In particular, the user profile information may indicate whether a particular user is in some way connected to an influencer, as discussed above. The user devices associated with the user account preference information may become targeted recipients of the promoted media content based on one or more characteristics of the user account information.

According to certain additional aspects of the present disclosure, consumers may be rewarded for identifying select media titles that later become popular or profitable for advertising purposes. A user account on a content website may be given a certain amount of credits each time a content title is submitted or identified to the server 401 and that title later becomes viral. If a consumer fails to provide a title that ultimately proves to be popular, the credit on the consumer's account may be reduced by a certain amount to keep their efforts honest and filtered to avoid over usage of such a content promotion function.

Any of the actions or operations described or depicted herein may be embodied directly in hardware, in a computer program executed by a processor, and/or in a combination of the two. A computer program may be embodied on a non-transitory computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method, comprising:
gathering relevant information for a plurality of consumers, wherein the relevant information is generated by a plurality of electronic devices configured to communicate over a network, wherein the relevant information for a given consumer in the plurality is relevant to influence of the given consumer on other consumers;
for each given consumer in the plurality determining a correlation between the relevant information for the given consumer to one or more items, and determining influence information from the correlation, wherein the relevant information includes a number or proportion of other consumers who acted on recommendations of items received from the given consumer;
storing influence information to one or more storage devices or transmitting the information to one or more electronic devices; and
electronically targeting a promotion toward devices used by one or more influencers in a group of influencers who are connected to each other.

2. The method of claim 1, wherein the relevant information includes a type of item recommended by the given consumer to one or more other consumers.

3. The method of claim 1, wherein the relevant information includes information identifying one or more other consumers who received recommendations for an item from the given consumer.

4. The method of claim 1, wherein the number or proportion of other consumers who acted on recommendations of items received from the given consumer includes a number or proportion of other consumers acted on recommendations of items received from the given consumer by spending time with a recommended item, writing about the recommend item online, or indicating approval of the item via a social media service.

5. The method of claim 1, wherein targeting the promotion includes strategically placing cookies for one advertisements related to the promotion on a website of an influencer in the group of influencers.

6. The method of claim 1, wherein determining the correlation includes examining historical data for popularity of one or more items in a given category and performing a statistical correlation between an abrupt increase in popularity of the one or more items and recommendations of the one or more items by a given consumer over a window of time preceding the abrupt increase.

7. The method of claim 1 wherein the influence information includes an identifier associated with the consumer, a list of one or more relevant categories of items, and corresponding influence ratings for each relevant category.

8. The method of claim 6, wherein the one or more relevant categories are organized in terms of the type of item.

9. The method of claim 1, wherein the influence information includes identifiers of one or more connected consumers having a relationship to the given consumer.

10. The method of claim 9 wherein the one or more connected consumers include one or more other consumers to whom the given consumer regularly sends recommendations.

11. The method of claim 9 wherein the one or more connected consumers include one or more other consumers having a known or knowable social relationship to the given consumer.

12. The method of claim 1 wherein the influence information is organized for display in the form of a heat map.

13. A device comprising:
a processor;
a memory coupled to the processor;
processor executable instructions stored in the memory and executable by the processor, wherein instructions are configured to implement a method upon execution by the processor, the method comprising gathering relevant information for a plurality of consumers, wherein the relevant information is generated by a plurality of electronic devices configured to communicate over a network, wherein the relevant information for a given consumer in the plurality is relevant to influence of the given consumer on other consumers; for each given consumer in the plurality determining a correlation between the relevant information for the given consumer to one or more items, and determining influence information from the correlation, wherein the relevant information includes a number or proportion of other consumers who acted on recommendations of items received from the given consumer; storing influence information to one or more storage devices or transmitting the information to one or more electronic devices; and electronically targeting a promotion toward devices used by one or more influencers in a group of influencers who are connected to each other.

14. A non-transitory computer readable storage medium having computer-executable instructions embodied therein, the instructions being configured to implement a method upon execution by a processor, the method comprising gathering relevant information for a plurality of consumers, wherein the relevant information is generated by a plurality of electronic devices configured to communicate over a network, wherein the relevant information for a given consumer in the plurality is relevant to influence of the given consumer on other consumers; for each given consumer in the plurality determining a correlation between the relevant information for the given consumer to one or more items, and determining influence information from the correlation, wherein the relevant information includes a number or proportion of other consumers who acted on recommendations of items received from the given consumer; storing influence information to one or more storage devices or transmitting the information to one or more electronic devices; and electronically targeting a promotion toward devices used by one or more influencers in a group of influencers who are connected to each other.

15. A method, comprising:
identifying one or more influencers from among a plurality of consumers from historical information regarding past consumer behavior;
gathering information from contemporary online behavior of the one or more influencers with respect to one or more categories of items;
identifying a trend with respect to one or more particular items in the one or more categories: and
storing information regarding the trend to one or more storage devices or transmitting the information to one or more electronic devices.

16. The method of claim 15, further comprising electronically targeting a promotion related to the trend toward devices used by one or more influencers in a group of influencers who are connected to each other

17. The method of claim 15, wherein identifying the one or more influencers includes gathering relevant information for a plurality of consumers, wherein the relevant information is generated by a plurality of electronic devices configured to communicate over a network, wherein the relevant information for a given consumer in the plurality is relevant to influence of the given consumer on other consumers;
for each given consumer in the plurality determining a correlation between the relevant information for the given consumer to one or more items, and determining influence information from the correlation; and
storing influence information to one or more storage devices or transmitting the information to one or more electronic devices.

18. The method of claim 17, wherein the relevant information includes a number or proportion of other consumers who acted on recommendations of items received from the given consumer.

19. The method of claim 15, further comprising, sending a media including an advertisement and a content item associated with an identified trend to one or more targeted recipients.

20. The method of claim 17, wherein the targeted recipients are selected from among consumers connected to the one or more influencers.

21. The method of claim 17, wherein the media file is sent electronically to one or more devices belonging to the targeted recipients.

22. The method of claim 15, wherein identifying the trend includes determining a growth in popularity of a content item among a group of consumers in the plurality that includes the one or more influencers.

23. The method of claim 20, wherein determining growth in popularity includes receiving user information from one or more devices associated with the group of consumers indicating popularity of one or more items.

24. The method of claim 21, wherein the user information includes at least one identifier which identifies an item of content and a user account.

25. The method of claim 15, further comprising providing an award to one or more accounts belonging to one or more of the influencers, when the influencers are associated with promoting the trend.

26. The method of claim 15, further comprising verifying the trend by implementing an online cross-referencing function, wherein the cross-referencing function is independent of the contemporary online behavior of the one or more influencers.

27. A device comprising:
a processor;
a memory coupled to the processor;
processor executable instructions stored in the memory and executable by the processor, wherein instructions are configured to implement a method upon execution by the processor, the method comprising identifying one or more influencers from among a plurality of consumers from historical information regarding past consumer behavior;
gathering information from contemporary online behavior of the one or more influencers with respect to one or more categories of items;
identifying a trend with respect to one or more particular items in the one or more categories; and
storing information regarding the trend to one or more storage devices or transmitting the information to one or more electronic devices.

28. A non-transitory computer readable storage medium having computer-executable instructions embodied therein, the instructions being configured to implement a method upon execution by a processor, the method comprising identifying one or more influencers from among a plurality of consumers from historical information regarding past consumer behavior;
gathering information from contemporary online behavior of the one or more influencers with respect to one or more categories of items;
identifying a trend with respect to one or more particular items in the one or more categories: and
storing information regarding the trend to one or more storage devices or transmitting the information to one or more electronic devices.
